(19) United States
(12) Patent Application Publication
(10) Pub. No.: US 2022/0133442 A1
(43) Pub. Date: May 5, 2022

(54) IMPRESSION POST FOR CONNECTION TO A DENTAL IMPLANT

(71) Applicant: CHAMPIONS DENTAL INTERNATIONAL GMBH, Lachen (CH)

(72) Inventors: Armin NEDJAT, Lachen (CH); Norbert BOMBA, Wiesbaden (DE)

(73) Assignee: CHAMPIONS DENTAL INTERNATIONAL GMBH, Lachen (CH)

(21) Appl. No.: 17/578,641

(22) Filed: Jan. 19, 2022

Related U.S. Application Data
(63) Continuation of application No. PCT/EP2020/000127, filed on Jul. 7, 2020.

(30) Foreign Application Priority Data
Jul. 19, 2019 (DE) 10 2019 005 040.1

(51) Int. Cl. A61C 8/00

(52) U.S. Cl. CPC A61C 8/0001; A61C 8/0012

(57) ABSTRACT

An impression post for connection to a dental implant, the impression post having a post element being connectible to the dental implant, is disclosed. An annular emergence element is detachably connected to the post element. An inner diameter of the emergence element is configured and adapted to an outer diameter of an axial portion on the post element, and the emergence element can be held in place in a predeterminable axial position of a longitudinal extent of the post element by a positioning element.

### RELATED APPLICATIONS

This application claims priority as a continuation application under 35 U.S.C. § 120 to PCT/EP2020/000127, which was filed as an International Application on Jul. 7, 2020 designating the U.S., and which claims priority to German Application 10 2019 005 040.1 filed in Germany on Jul. 19, 2019. The entire contents of these applications are hereby incorporated by reference in their entireties.

### FIELD

The present disclosure relates to an impression post for connection to a dental implant, a post element being connectible to the dental implant.

### BACKGROUND INFORMATION

It is known to screw an implant body into a human jawbone by means of a tool in order to replace missing tooth roots. After the implant body has been inserted into the jawbone, the implant body is usually closed by a cover screw in order to prevent the penetration of germs. The arrangement of the implant body and cover screw remains in the patient's jaw for a certain time without further treatment in order to allow the jawbone to fuse with the implant body.

The cover screw is later loosened from the implant body and a so-called gingiva former is placed on the implant body instead. The gingiva former is intended to prepare the gums for receiving a dental prosthesis. The shape of the gingiva former is usually adapted to the dental prosthesis that is to be attached later and effects a corresponding shaping of the gums.

An impression will be made at a further appointment. For this purpose, the gingiva former is replaced by a so-called impression post. In addition, the gingiva-free region, which was created by the gingiva former for the subsequent dental prosthesis, is injected with a special compound so that the subsequent dental prosthesis also has the desired shape adapted to the gingiva. In this way, the position of the subsequent dental prosthesis in the jaw can also be readjusted in a dental laboratory and the dental prosthesis can be prepared for placement on the implant body.

At a further appointment, the dental prosthesis prefabricated in the laboratory is attached. For this purpose, a so-called abutment is first placed on the screwed-in implant body and anchored, namely preferably screwed, in the implant body. In a final step, the artificial dental prosthesis is then placed on the abutment. In the above work steps, particular care must be taken to prevent germs from penetrating into the interior of the implant body.

A disadvantage of known implant technology is that the result of the injection of the gingiva-free region with the special compound depends, on the one hand, on the manual skills of the dentist performing the procedure and therefore quality is not always consistent. On the other hand, the injection takes a comparatively long time.

Further, the present disclosure describes an impression post which avoids or at least reduces disadvantages of the known technologies.

### SUMMARY

An impression post is disclosed for connection to a dental implant, the impression post comprising a post element configured to be connectible to a dental implant; and an annular emergence element detachably connected to the post element, an inner diameter of the emergence element being configured and adapted to an outer diameter of an axial portion on the post element, and the emergence element being held in place in a predeterminable axial position of a longitudinal extent of the post element by a positioning element.

### BRIEF DESCRIPTION OF THE DRAWINGS

Other features and advantages of the present disclosure will become more apparent upon reading the following detailed description in conjunction with the accompanying drawings, wherein:

FIG. 1 is a view of an exemplary impression post.

### DETAILED DESCRIPTION

An impression post is disclosed herein for connection to a dental implant, a post element being connectible to the dental implant. An exemplary impression post is characterized in that an annular emergence element is detachably connected to the post element by means of a positioning element, in that an inner diameter of the emergence element is configured and adapted to an outer diameter of an axial portion on the post element, and in that the emergence element is held in place in a predeterminable axial position of a longitudinal extent of the post element by means of the positioning element.

Rather than a known one-piece impression post, an exemplary impression post is disclosed which has two structural elements, and includes a post element and an emergence element. The emergence element can be connected to the post element in such a way that—when the impression post is inserted into the implant—it is positioned exactly at a point where the gingiva former was previously. In addition, the shape of the side of the emergence element facing the gingiva is selected so that it corresponds to the gingiva former.

Exemplary embodiments include a plurality of emergence elements which can be connected to the post element depending on a patient's needs. For this purpose, the emergence element is detachably connected to the post element. The sides of the gingiva former facing the gingiva and the corresponding side of the emergence element for a specific treatment case are therefore matched to one another, while sides of each emergence element facing the post element are configured and designed to be essentially the same so that they can each be connected to a specific post element.

By selecting an emergence element that corresponds to the gingiva formed by the gingiva former, the treating dentist is able to obtain an impression post that is precisely adapted to the previously formed gingiva by connecting the selected emergence element to the standardized post element. It can also be said that the impression post is configured and adapted to the shape of the gingiva former by the post element together with the emergence element for the region of the patient's gums, in addition to its function as an impression post. The previous injection with a special compound to simulate the shape of the gingiva former can advantageously be completely dispensed with. The insertion of the impression post and the preparation of the impression for producing the dental prosthesis are also made correspondingly faster. In addition, the emergence element is machine-made. This can be associated with a consistent quality that cannot be achieved by the manual creation of a comparable emergence profile.

According to an exemplary embodiment of an impression post according to the present disclosure, the post element includes a recess in the direction of its longitudinal extent, the recess being suitable for receiving a fastening screw. It is thus possible to connect the post element to the implant by means of, for example, a fastening screw. A screw head of the fastening screw is held in place or guided in the recess, on the one hand, and the thread of the fastening screw protrudes beyond an end face of the post element, so that the thread can be screwed into the implant. The screw head rests, for example, on a shoulder within the recess. However, the screw head can also have a diameter that is smaller than the smallest clear diameter of the recess. The fastening screw can then be only used for axial guidance and positioning of the impression post. The post element of the impression post is then connected to the implant by the contact point between the two components. Through the process of making the impression for producing the dental prosthesis, the impression post is pressed against the implant and is thus held in place in its correct axial position and connected thereto. A further possibility for connecting the impression post to the implant provides that the post element includes a thread on its side facing the implant, with which the post element can be screwed into the implant directly.

According to an exemplary variant of the impression post according to the present disclosure, the surface of the axial portion on the post element facing the emergence element is configured and designed in the form of a cylindrical casing. With this shape, a particularly simple placement and connection of the emergence element on or with the post element is achieved. In addition, particularly easy guidance of the emergence element when it is placed on the post element is made possible.

According to an exemplary embodiment of the impression post, a surface of the axial portion on the post element facing the emergence element is partially connected to the emergence element. The axial portion on the post element does not necessarily have to be completely cylindrical, for example. This is because grooves or other markings can also be provided in order, for example, to particularly easily identify or determine when a certain position of the emergence element has been reached.

An advantageous development of the impression post provides that the positioning element is configured and designed as a collar on the emergence element, which collar at least partially has a smaller diameter than the inner diameter of the emergence element, that the post element includes a stop that is configured and adapted to the collar, and that the collar rests against the stop. The stop can be located on the side of the axial portion on the post element facing the implant. However, it can be particularly advantageous if the stop is located on the side of the axial portion facing away from the implant on the post element. The post element is then configured and designed in particular such that its axial portion has the largest diameter. All other diameters on the post element are also smaller than the clear diameter of the collar. This ensures that the emergence element can be changed while the post element is mounted or pushed onto the implant.

An alternative exemplary embodiment of the impression post is characterized in that the positioning element is configured and designed as a mutually adapted groove-and-projection combination on the emergence element or on the post element. It is irrelevant in such an embodiment whether the groove is arranged on the emergence element and the projection is arranged on the post element, in particular on the axial portion, or vice versa. In such an embodiment, it can be particularly helpful that the groove-and-projection combination is configured and designed in such a way that the emergence element can be easily changed. This is achieved by keeping either the projection or the tongue so small that the resistance when inserting or locking into the groove can easily be overcome by the treating dentist. For this purpose, the emergence element can be for example made of a suitably flexible material, for example polyetheretherketone (PEEK).

A particular exemplary connection between the post element and the emergence element is characterized in that the inner diameter of the emergence element is configured and adapted to the outer diameter of an axial portion with a press fit as a connection to one another. The press fit is selected in such a way that it is particularly easy for the treating dentist to attach or remove a selected emergence element from the post element. A quick change of an emergence element on the post element and a replacement by another selected emergence element are hereby made possible in a particularly simple and comparatively fast manner.

According to an exemplary variant of the impression post according to the present disclosure, a region of the emergence element facing away from the post element has a shape adapted to the gingiva in the dental implant. The shape of the gingiva can be determined or configured and designed beforehand by means of a gingiva former. Thus, the shape of the gingiva is basically known or has been specified by the gingiva former used. By harmonizing the shapes of the gingiva former and the emergence element for the region facing the gingiva, it can be particularly easy to select an emergence element that, together with the post element, provides an impression post that exactly matches the gingiva formed by the gingiva former in the region of the gingiva.

For the impression post the emergence element can, for example, be made of titanium, another metal, a metal or titanium alloy, plastics, flexible plastics, titanium oxide, ceramics or polyetheretherketone (PEEK).

Further advantageous developments will be apparent to those skilled in the art based on the following discussion of exemplary embodiments shown in the drawing.

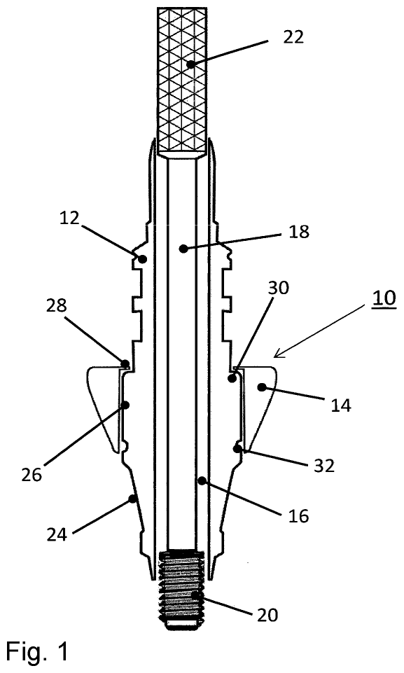

FIG. 1, as the only FIGURE, is a view of an exemplary impression post 10 which includes a post element 12 and an emergence element 14. The post element 12 has a through recess 16 as a recess along its longitudinal extent and along an imaginary line of symmetry. In addition, a guide screw 18 is shown in the through recess 16, in which—in the drawing—a thread 20 is attached. With the thread 20, the guide screw 18 can be screwed into an implant (not shown in FIG. 1). In this way, the post element 12 of the impression post 10 is connected to the implant to form an arrangement of an implant with an impression post. In the example shown, a screw head 22 has a smaller diameter than a clear diameter of the through recess 16. In this way, the post element 12 is guided axially along the guide screw 18. For the exact axial positioning of the post element 12 on the implant, a conical portion 24 is provided on the side facing the implant, the conical portion corresponding to a corresponding negative conical portion on the implant and thus being connected to the implant. In addition, this cyan form an axial stop for positioning the post element 12.

A cylindrical portion 26 is formed on the post element 12, that is to say a portion whose radially outwardly facing surface or side is in the form of a cylindrical casing. The emergence element 14 is connected to the cylindrical portion 26 by means of, for example, a press fit. The press fit is configured and designed in such a way that the emergence element 14 is securely held in place on the post element 12 for the dentist to make an impression and can also be removed by the dentist without tools, e.g., with manual force. For an exact axial positioning of the emergence element 14 on the post element 12, a collar 28 is also molded as a positioning element on the emergence element 14, which rests against a shoulder 30 that serves as an axial stop for the collar 28. The cylindrical portion 26 is located in the axial direction of the post element 12 so that an emergence element 14, which rests with its collar 28 on the shoulder 30, is positioned exactly at the point where a gingiva former was previously located after the impression post 10 has been screwed onto an implant in the jaw. In the example described here, the post element 12 is made of titanium, while the emergence element 14 is made of polyetheretherketone (PEEK). With this combination of materials, the press fit described above can be implemented in a particularly simple and advantageous manner.

As an alternative or in addition to the collar 28, the emergence element 14 can also be positioned on the post element 12 with a tongue-and-groove connection of any type. For example, a tongue as a positioning element can in an exemplary case be implemented by a projection molding on a side of the emergence element 14 facing the post element which is to mate with a group, although such a tongue projection is not specifically shown in FIG. 1. In FIG. 1, however, an exemplary groove 32 for a tongue-and-groove connection is provided and shown as an alternative positioning element on the cylindrical portion 26, in which the tongue or a locking ring can optionally be latched or introduced. An exemplary advantage of a tongue-and-groove connection is that the molding on different emergence elements can take place at different axial positions, so that a plurality of variants with different axial positions of emergence elements of the same configuration and design can be implemented particularly easily.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SIGNS

10 Impression post
12 Post element
14 Emergence element
16 Through recess
18 Guide screw
20 Thread
22 Screw head
24 Conical portion
26 Cylindrical portion
28 Collar
30 Shoulder
32 Groove

1. Impression post for connection to a dental implant, the impression post comprising:
a post element configured to be connectible to a dental implant; and
an annular emergence element detachably connected to the post element, an inner diameter of the emergence element being configured and adapted to an outer diameter of an axial portion on the post element, and the emergence element being held in place in a predeterminable axial position of a longitudinal extent of the post element by a positioning element.

2. Impression post according to claim 1, wherein the post element comprises:
a recess in a direction of a longitudinal extent of the post element, the recess being suitable for receiving a screw.

3. Impression post according to claim 1, wherein a surface of the axial portion on the post element facing the emergence element is formed as a cylindrical casing.

4. Impression post according to claim 1, wherein a surface of the axial portion on the post element facing the emergence element is partially connected to the emergence element.

5. Impression post according to claim 1, wherein the positioning element is configured and designed as a collar on the emergence element, which collar at least partially has a smaller diameter than an inner diameter of the emergence element, the post element comprising:
a stop that is configured and adapted to the collar, such that the collar will rest against the stop.

6. Impression post according to claim 1, wherein the positioning element is configured and designed as a mutually adapted groove-and-projection combination on the emergence element or on the post element.

7. Impression post according to claim 1, wherein the inner diameter of the emergence element is configured and adapted to an outer diameter of an axial portion with a press fit as a connection to one another.

8. Impression post according to claim 1, wherein a region of the emergence element facing away from the post element has a shape which is configured and adapted to a gingiva formed by a gingiva former.

9. Impression post according to claim 1, wherein the emergence element and/or the post element is made of titanium, another metal, an alloy, plastics, flexible plastics, titanium oxide, ceramics or polyetheretherketone (PEEK).

10. Impression post according to claim 2, wherein a surface of the axial portion on the post element facing the emergence element is formed as a cylindrical casing.

11. Impression post according to claim 10, wherein a surface of the axial portion on the post element facing the emergence element is partially connected to the emergence element.

12. Impression post according to claim 11, wherein the positioning element is configured and designed as a collar on the emergence element, which collar at least partially has a smaller diameter than an inner diameter of the emergence element, the post element comprising:
a stop that is configured and adapted to the collar, such that the collar will rest against the stop.

13. Impression post according to claim 12, wherein the positioning element is configured and designed as a mutually adapted groove-and-projection combination on the emergence element or on the post element.

14. Impression post according to claim 13, wherein the inner diameter of the emergence element is configured and adapted to an outer diameter of an axial portion with a press fit as a connection to one another.

15. Impression post according to claim 14, wherein a region of the emergence element facing away from the post element has a shape which is configured and adapted to a gingiva formed by a gingiva former.

16. Impression post according to claim 15, wherein the emergence element and/or the post element is made of titanium, another metal, an alloy, plastics, flexible plastics, titanium oxide, ceramics or polyetheretherketone (PEEK).
